(19) United States
(12) Patent Application Publication
(10) Pub. No.: US 2021/0131130 A1
(43) Pub. Date: May 6, 2021

(54) DEVICE FOR PRODUCING A REINFORCED SWIMMING POOL

(71) Applicant: Veni Vidi Vici Limited, Kowloon (HK)

(72) Inventor: Jean-Paul SACCUCCI, Veauche (FR)

(73) Assignee: Veni Vidi Vici Limited, Kowloon (HK)

(21) Appl. No.: 16/639,596

(22) PCT Filed: Aug. 8, 2018
(86) PCT No.: PCT/FR2018/052035

§ 371 Date: Feb. 17, 2020

(30) Foreign Application Priority Data
Aug. 17, 2017 (FR) 1757710

(51) Int. Cl. E04H 4/00; B32B 3/12

(52) U.S. Cl. CPC E04H 4/005; B32B 2607/00; B32B 3/12

(57) ABSTRACT

The invention relates to a device (1) for producing a swimming pool comprising panels (2) that have an internal structure (4) of the cellular type and each comprise a peripheral frame (5) that forms upper (5a) and lower (5b) edges, and vertical edge faces (5c) that are joined in a leaktight manner by coupling profiles (3) so as to form a closed volume of any desired geometric shape corresponding to said pool. According to the invention, the peripheral frame (5) of each panel (2) comprises, on the inside, at least one upright (6) and at least one cross member (7) so as to define at least four receiving zones (8) inside the frame that each receive an independent structure (4) of the cellular type.

### TECHNICAL FIELD

The invention relates to the technical sector of swimming pools and, more particularly, it relates to a device for the production of a reinforced above-ground, semi-inground or inground swimming pool basin.

### PRIOR ART

Different solutions have been proposed for producing a swimming pool basin from several panels assembled therebetween, according to different means and arrangements, to obtain a basin of any geometric shape, whether square, rectangular, polygonal, or other.

In particular, a device for the production of a swimming pool basin is known, comprising panels having an internal structure of the cellular type and each comprising a peripheral frame constituting the upper and lower edges, and vertical edges assembled in a sealed manner by coupling profiles so as to form a closed volume of any geometric shape corresponding to said basin.

It is apparent from the prior art that the internal structure of the panels ensures a very high rigidity, avoiding any phenomenon of bending or buckling thereof under the effect of a strong pressure exerted by the water in the swimming pool basin, or by the ground.

This type of solution is entirely satisfactory, but can still be improved, especially in terms of rigidity and thickness.

### BRIEF DESCRIPTION OF THE INVENTION

One of the aims of the invention is therefore to remedy the disadvantages of the prior art by proposing a device for producing a swimming pool basin comprising panels of optimal rigidity, while having minimal thickness.

To this end, a device has been developed for producing a swimming pool basin comprising panels having an internal structure of the cellular type, and each comprising a peripheral frame that forms upper and lower edges, and vertical edges assembled in a sealed manner by coupling profiles so as to form a closed volume of any geometric shape corresponding to said basin.

According to the invention, the peripheral frame of each panel comprises internally at least one upright and at least one cross member so as to define at least four receiving zones inside said frame, each receiving an independent structure of the cellular type.

In this way, the rigidity of the panels is optimal, said panels thus being able to have a smaller thickness, which also guarantees a significant weight gain.

Preferably, each panel comprises two parallel plates constituting the inner and outer faces of the panel, which are fixed to the peripheral frame, but preferably also to the uprights and the cross members.

In this way, the plates constituting the external faces of the basin can receive different types of facing, while optimally withstanding the weight of said facing.

According to a particular embodiment, each upright and each cross member comprises an “H”-shaped section to define two housings for receiving edges of the structures of cellular type.

### BRIEF DESCRIPTION OF THE FIGURES

Other advantages and characteristics will emerge from the following description of the invention, provided by way of non-limiting example, based on the appended drawings in which:

FIG. 1 is a perspective view of a non-limiting example of a swimming pool basin produced according to the device of the invention;

FIG. 2 is a perspective view of a panel with partial cross section in order to show the interior of the cellular-type honeycomb structure;

FIG. 3 is a view in longitudinal section of the panel as seen from the front;

FIGS. 4 and 4b is are cross-sectional views of the panel along the line A-A of FIG. 3, according to two possible embodiments;

FIG. 5 is a partial cross-sectional view showing the assembly in linear alignment of two panels by means of the coupling profiles according to the invention;

FIG. 6 is a partial sectional view showing the angular assembly of two panels by means of the coupling elements according to the invention.

### DETAILED DESCRIPTION OF THE INVENTION

Referring to FIGS. 1 to 6, the device (1) according to the invention is advantageously applied for the production of all types of structures, in particular for the production of a basin of any geometric shape, with the objective of producing a swimming pool of the inground, semi-inground or above-ground type.

In a known manner, the basin, the geometric shape of which is depicted in FIG. 1 is given by way of non-limiting indication, comprises panels (2) coupled in a sealed manner by a set of coupling profiles (3).

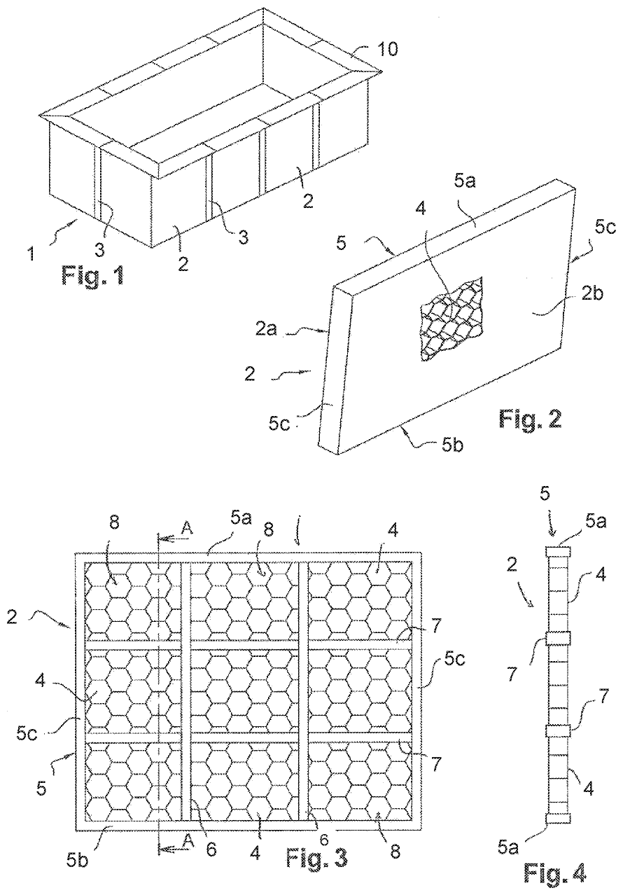

Referring to FIG. 2, and in order to improve the rigidity of the panels (2), said panels have an internal structure (4) of the cellular type, advantageously in a honeycomb form. Referring to FIG. 3, each panel (2) comprises a peripheral frame (5) constituting upper (5a) and lower (5b) edges, and vertical edges (5c). The vertical edges (5c) of two adjacent frames (5) are joined together by the coupling profiles (3) so as to form a closed volume corresponding to said basin.

According to the invention, the peripheral frame (5) of each panel (2) comprises internally at least one upright (6) and at least one cross member (7) so as to define at least four receiving zones (8) inside the frame (5), each receiving an independent structure (4) of the cellular type.

This allows to considerably improve the rigidity of the panels (2), while thus allowing to reduce its thickness and therefore to minimize the weight.

In a preferred embodiment, and depending on the size of the panels (2), each panel (2) comprises a plurality of uprights (6), for example two, and a plurality of cross members (7), for example two, to define a plurality of receiving zones (8), for example nine.

Each receiving zone (8) is thus intended to receive a structure (4) of cellular type, preferably in honeycomb form, in the form of a plate, for example, the cells of which are, for example, oriented perpendicularly to the inner (2a) and outer (2b) faces of the panel (2). Without departing from the scope of the invention, the cells can also be oriented parallel to said inner (2a) and outer (2b) faces of the panel (2).

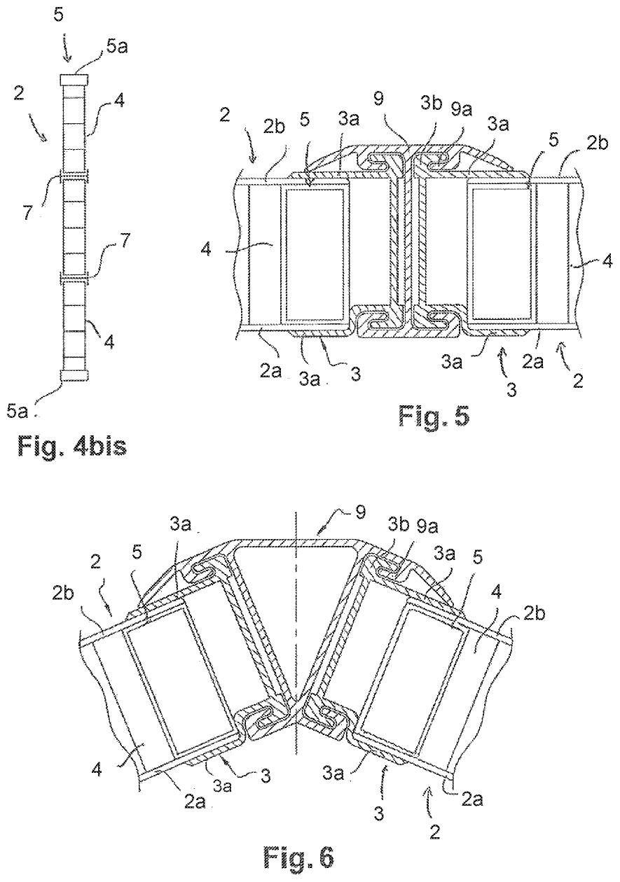

Referring to FIG. 4, the uprights (6) and the cross members (7) comprise rectangular sections. However, in order to facilitate assembly, and to optimally maintain the structures (4) of the cellular type within the receiving zones (8), each upright (6) and each cross member (7), referring to FIG. 4b is, may comprise an “H”-shaped section to each define two housings for receiving edges of the structures (4) of the cellular type. More precisely, each upright (6) and each cross member (7) comprises a central web bordered by two portions parallel to the inner (2a) and outer (2b) faces of the panel (2), and extending orthogonally and on either side of the central web to define the “H” shape. As indicated, the edges of the internal structures (4) of the cellular type are therefore inserted inside the housings defined by the “H” shape, between the two parallel wall portions of each upright (6) and each cross member (7).

In this way, after assembly, the cellular structures (4) are maintained in the plane of the panel (2).

The internal structures (4) of the cellular type are then sandwiched between two parallel and non-jointed plates constituting the inner (2a) and outer (2b) faces of the panel (2). These plates (2a, 2b) are fixed, for example, by rivets or adhesive bonding, to the peripheral frame (5). Preferably, and in order to improve the rigidity, the plates (2a, 2b) are also fixed to the uprights (6) and the cross members (7). In this way, the plates (2a, 2b) are fixed in an optimal way, and can withstand and support any type of facing.

The vertical edges (5c) of the panels (2) as defined according to the features of the invention, cooperate with the set of coupling profiles (3) so as to form the closed volume having a geometric shape corresponding to that desired for the production of the swimming pool basin. The coupling profiles (3) have parallel covering flanges (3a) capable of grasping the section of the panel (2), i.e. the faces (2a, 2b) of the latter, at each of their vertical edges (5c). Each of the profiles (3) has, at the flanges (3a), outside the vertical edges (5c) of the panels (2), coupling shapes (3b) that are capable of cooperating with complementary shapes (9a) of an intermediate connecting element (9). In other words, the intermediate element (9) ensures the connection between the profiles (3) of two adjacent panels (2) with a view to the coupling thereof. This intermediate element (9) can be straight, see FIG. 5, to allow an aligned coupling of two adjacent panels (2), or curved, see FIG. 6, to allow an angular coupling of two adjacent panels (2). It should be noted that the coupling profiles (3) can be attached to the ends of the panels (2) by any known and appropriate means such as adhesive bonding, screwing or riveting. Preferably, the flanges (3a) of the coupling profiles (3) are riveted on either side of the peripheral frame (5) to ensure optimal holding power and sufficient rigidity to take account of the thrust forces of the water and optionally the ground.

Finally, after assembly of the panels (2), as previously indicated, the latter can be fitted, at their upper edge, with an attached element (10), suitable for attaching a liner. This element (10) may also have an upper edge comprising an overhanging part capable of also acting as a curbstone by projecting on the side considered to the outside of the basin.

The advantages are clear from the description, in particular the design of the panel (2) is emphasized and recalled, the internal structure (4) of the cellular type of which, in combination with the uprights (6) and cross members (7) of the frame, ensures sufficient rigidity to take account of the thrust forces of the water and optionally of the ground, while at the same time being lighter and thinner than the panel (2) of the state of the art. The plates (2b) constituting the external faces of the panels (2) are more resistant and can support any type of facing.

Of course, the connection of the panels (2) with the bottom of the swimming pool is carried out by any known and appropriate means. In the same way, in the case of an inground pool, the panels (2) are able to cooperate with any stability element such as props.

What is claimed is:

1. A device (1) for producing a swimming pool comprising panels (2) that have an internal structure (4) of the cellular type and each comprising a peripheral frame (5) that forms upper (5a) and lower (5b) edges, and vertical edges (5c) that are joined in a sealed manner by coupling profiles (3) so as to form a closed volume of any geometric shape corresponding to said basin, characterized in that the peripheral frame (5) of each panel (2) comprises internally at least one upright (6) and at least one cross member (7) so as to define at least four receiving zones (8) inside the frame each receiving an independent structure (4) of the cellular type.

2. The device (1) according to claim 1, characterized in that each panel (2) comprises internally a plurality of uprights (6) and a plurality of cross members (7) defining a plurality of receiving zones (8) of independent structures (4) of the cellular type.

3. The device (1) according to claim 1, characterized in that each panel (2) comprises two parallel plates constituting inner (2a) and outer (2b) faces of the panel (2), fixed to the peripheral frame (5).

4. The device (1) according to claim 3, characterized in that the parallel plates (2a, 2b) are also fixed to the uprights (6) and cross members (7).

5. The device (1) according to claim 1, characterized in that each upright (6) and each cross member (7) comprise an “H”-shaped section to define two housings for receiving edges of the structures (4) of the cellular type.
